(19) United States
(12) Patent Application Publication
(10) Pub. No.: US 2004/0197461 A1
(43) Pub. Date: Oct. 7, 2004

(54) Edible fungi

(76) Inventors: Timothy John Andrew Finnigan, North Yorkshire (GB); Robin Blanchard, North Yorkshire (GB)

Correspondence Address: MICHAEL BEST & FRIEDRICH, LLP, 100 E WISCONSIN AVENUE, MILWAUKEE, WI, 53202, US

(21) Appl. No.: 10/476,835

(22) PCT Filed: May 7, 2002
(86) PCT No.: PCT/GB02/02089

(30) Foreign Application Priority Data
May 4, 2001 (GB) 0110953.7

(51) Int. Cl. A23L 1/168

(52) U.S. Cl. 426/619

(57) ABSTRACT

A solid food ingredient comprising edible fungal particles especially consisting substantially of fungal mycelia is described. The ingredient may be combined with other ingredients to produce a wide range of foodstuffs or food ingredients including desserts (e.g. yoghurt), reconstitutable drinks or soup and extruded foodstuffs, (e.g. savoury snack foods). Foodstuffs prepared may have medical applications (e.g. for treatment of joint mobility disorders, reducing fat uptake, lowering cholesterol, immune function stimulators, use as a pre-biotic and/or for affecting satiety).

This invention relates to edible fungi and provides a solid first food ingredient, the use thereof, a method of preparing a foodstuff and a foodstuff per se, especially an extruded foodstuff. The invention also provides methods and uses of edible fungi in the promotion of good health.

It is known, for example from WO 00/15045 (DSM), WO96/21362 (Zeneca) and WO95/23843 (Zeneca) to use edible filamentous fungi as meat-substitutes, for example in the preparation of burgers and sausages. In such uses, filaments of the fungi are bound together, for example with egg albumin, and are texturised so that the product resembles muscle fibres and therefore has a meat-like appearance and texture. Meat substitutes of the type described have been widely commercially available for many years under the trade mark QUORN.

The present invention, in one aspect, is based on the discovery that edible fungi can be arranged to act as fat mimetics (in sharp contrast with known uses where-they are arranged to be meat-like and mimic muscle fibres) and be used in a range of foodstuffs with excellent consumer acceptability.

It is also well-known to deliver active ingredients (e.g. vitamins, minerals, pharmaceuticals etc) in tablet (or other dosage) forms. Active ingredients may be prepared synthetically, then isolated and tableted. Alternatively, active ingredients may be extracted from raw materials containing them and then tableted. It is also known to fortify foods with active ingredients (e.g. vitamins). However, in the aforesaid cases, a concentrate of substantially pure active ingredient is incorporated into the food, at low concentration and so as to have negligible effect on the functionality, taste and/or rheology of the food. Disadvantageously, the preparation of concentrates of active ingredients can be expensive. Furthermore, it is difficult to deliver sufficiently high levels of a range of desired active ingredients without detrimentally affecting the quality of the food.

The present invention, in another aspect, is based on the discovery of a means of delivering active ingredients into certain foodstuffs at levels at which they can provide positive health benefits and/or promote good health. Furthermore, at the same time, the means of delivering the active ingredients can replace ingredients (e.g. fat) in foodstuffs that may potentially be detrimental to good health and contribute positively to the functionality and/or rheology of the foodstuff.

Thus, it is an object of the present invention to provide foodstuffs which may be advantageous over known foodstuffs.

According to a first aspect of the invention, there is provided a solid first food ingredient comprising edible fungal particles having a dimension in a first direction of less than 200 μm, wherein said dimension in said first direction is a maximum dimension of said particles.

Measurement of dimensions of the fungal particles may involve dispersing the food ingredient in a solvent followed by measurement of the particles as described herein.

Said fungal particles preferably comprise a filamentous fungus. Said filamentous fungus preferably comprises fungal mycelia and suitably at least 80 wt %, preferably at least 90 wt %, more preferably at least 95 wt % and, especially, at least 99 wt % of the fungal particles in said food ingredient comprise fungal mycelia. Some filamentous fungi may include both fungal mycelia and fruiting bodies. Said fungal particles preferably comprise a filamentous fungus of a type which does not produce fruiting bodies. Where, however, a filamentous fungus of a type which produces fruiting bodies is used, the fungal particles of said food ingredient suitably include at least 80 wt %, preferably. at least 90 wt %, more preferably at least 95 wt % of fungal mycelia. Preferably, said fungal particles comprise substantially only fungal mycelia—that is, said fungal particles of said food ingredient preferably do not include any fruiting bodies.

Preferred fungi have a cell wall which includes chitin and/or chitosan. Preferred fungi have a cell wall which includes polymeric glucosamine. Preferred fungi have a cell wall which includes β1-3/1-6 glucans.

Said fungal particles may include fungal cells of the order Mucorales as described in WO 00/15045 (DSM).

Said fungal particles preferably comprise fungus selected from fungi imperfecti.

Preferably, said fungal particles comprise, and preferably consist essentially of, cells of Fusarium species, especially of Fusarium venenatum A3/5(formerly classified as Fusarium graminearum) (IMI 145425; ATCC PTA-2684 deposited with the American Type Culture Collection, 10801 University Boulevard, Manassas, Va.) as described for example in WO96/21361 (Zeneca) and WO95/23843 (Zeneca).

Edible fungi of said food ingredient are preferably not bound together by a binding agent, for example added to the fungi after they have been grown and/or harvested. Thus, said edible fungi need not be treated with (and, therefore, suitably are not associated with) hydrocolloids (e.g. starch, pectin, carrageenan or alginate) and/or with proteins. (e.g. milk protein such as casein, ovoprotein such as egg albumin or eggs themselves; vegetable proteins such as soy; cereal proteins, such as gluten; or enzymes such as proteases or phosphodiasterases). It is especially preferred that said edible fungi are not bound together by egg albumin.

Said food ingredient may include at least 30% w/w, preferably at least 40% w/w, especially at least 50% w/w of said edible fungal particles on a dry weight basis.

In a first embodiment, said food ingredient may include at least 80% w/w, at least 90% w/w or even at least 95% w/w of said edible fungal particles on a dry matter basis. In this case, said ingredient may include 20% w/w or less, 10% w/w or less, or 5% w/w or less of water. The ingredient may include 0-5% w/w water, typically 1-5% w/w water. The food ingredient of the first embodiment may be made by drying a mass of edible fungi, followed by a size reduction process as hereinafter described.

In a second embodiment, said food ingredient may include another source of protein, for example derived from milk, for example skim milk. Thus, in this case, said food ingredient may include milk solids. Preferably, said food ingredient includes less than 20% w/w, more preferably less than 15% w/w, especially less than 10% w/w of milk solids (on a dry weight basis).

Said food ingredient is preferably a particulate solid, for example a powder. Said food ingredient suitably includes less than 20% w/w, preferably less than 15% w/w, more preferably less than 10% w/w, especially less than 5% w/w water. Typically, said food ingredient include 0-10% w/w, preferably 0-5% w/w of water.

As described above, the edible fungal particles of the first aspect have a maximum dimension in a first direction of less than 200 μm. The maximum dimension suitably refers to the length of the fungal particles (especially when derived from a filamentous fungus) but the reference to length is not intended to exclude the possibility of there being two (or more) substantially equal maximum dimensions which may extend perpendicularly to each other. The number average of said first dimensions of said fungal particles in the food ingredient is suitably less than 200 μm, is preferably less than 100 μm, is more preferably less than 75 μm and is especially less than 50 μm. In some embodiments, said number average may be less than 40 μm, less than 30 μm or even less than 20 μm. The aforementioned smaller dimensions may be particularly useful for incorporation in certain foodstuffs.

The number average of said first dimensions may be at least 1 μm, preferably at least 5 μm, more preferably at least 10 μm.

Suitably, the mean of said first dimensions is less than 150 μm, preferably less than 100 μm, more preferably less than 75 μm, with a standard deviation on the mean of less than 200 μm, preferably less than 100 μm. The mean is preferably at least 10 μm.

Said edible fungal particles may have a dimension in a second direction, measured perpendicular to said first direction, which is suitably less than 20 μm, preferably less than 10 μm, more preferably less than 7 μm and especially 5 μm or less. Said dimension in said second direction is preferably at least 1 μm, more preferably at least 3 μm. Said dimension in said second direction is preferably a diameter of the particles and is preferably substantially the same as a dimension in a third direction, perpendicular to the dimension in said second direction. Thus, preferably said particles have a substantially circular cross-section.

The food ingredient of the first aspect may be prepared by subjecting an aqueous formulation comprising edible fungi to a size reduction process, followed by removal of water from the size reduced aqueous formulation to produce a solid product. Alternatively, a solid mass comprising edible fungi may be subjected to a size reduction process (e.g. milling or the like).

The food ingredient may include a sequestrating agent, for example disodium hydrogen phosphate.

The invention extends to a method of making a food ingredient as described according to said first aspect, the method comprising:

(a) subjecting an aqueous formulation comprising edible fungi to a size reduction process, followed by removal of water from the size reduced product: or

(b) subjecting a solid mass comprising edible fungi to a size reduction process.

In the method of step (a), the aqueous formulation may include milk solids. These may be provided by virtue of edible fungi being added to milk (e.g. skim milk) to prepare the aqueous formulation. The aqueous formulation prepared may then be treated as described in step (a). In the method of step (a), the titratable acidity (TA) of the formulation may be adjusted, suitably to a titratable acidity in the range 0.05 to 0.25. The pH may be adjusted to a pH in the range 6 to 7.6. When the aqueous formulation includes milk solids, means may be provided for reducing calcium bridging between casein micelles during subsequent removal of water. In the method, a sequestrating agent, for example disodium hydrogen phosphate may be provided in said aqueous formulation. In the method, initial removal of water may be achieved by evaporation. Subsequent removal may be accomplished by spray drying.

In the method of step (b), said size reduction process may be a milling process (or the like).

According to a second aspect of the invention, there is provided a solid first food ingredient comprising edible fungal particles having an average aspect ratio of less than 70.

For the avoidance of doubt, the average aspect ratio suitably refers to the average of the dimensions of the fungal particles in a first direction (e.g. the average length) divided by the average of the dimensions of the fungal particles in a second direction (e.g. diameter).

The average aspect ratio of the particles is suitably less than 65, preferably less than 60, more preferably less than 50, especially less than 40. In some embodiments, the average may be less than 30, less than 20, less than 15, less than 10 or even less than 5.

The aspect ratio may be an important parameter in producing desirable textures in some products incorporating said first food ingredient. For example, if the aspect ratio of solid particles is greater than 40, then on rehydration the hyphae may become entangled resulting in a texture which is undesirable for products such as yoghurts and beverages. However, for frozen desserts, entanglement may not be a problem since an entangled network may help improve melt down characteristics of frozen desserts.

The aspect ratios of the second aspect may be applied to the invention of the first aspect.

According to a third aspect of the invention, there is provided the use of a solid first food ingredient comprising edible fungal particles, suitably as described in the first and/or second aspects, in the preparation of a foodstuff for consumption or a second food ingredient.

According to a fourth aspect of the invention, there is provided a method of preparing a foodstuff for consumption or a second food ingredient, the method comprising contacting a solid first food ingredient comprising edible fungal particles and suitably being as described according to the first and/or second aspects, with other ingredients of said foodstuff or second food ingredient.

In a foodstuff for consumption, the amount of said first ingredient may be selected such that there is at least 2% w/w, preferably at least 3% w/w, more preferably at least 4.5% w/w of edible fungi (especially fungal mycelia or hyphae) on a dry matter basis.

In one embodiment, a foodstuff for consumption may be fluidic—that is, not a solid. Said foodstuff may be a dairy product, for example selected from a yoghurt, dessert e.g. ice-cream type dessert or milk drink.

Said other ingredients in the foodstuff of the embodiment and the amounts thereof will generally depend on the nature of the foodstuff prepared. However, ingredients common to a number of foodstuffs are suitably milk (e.g. skim milk) and/or milk (e.g. skim milk) powder. Thus, the method may involve contacting the first food ingredient with milk or milk powder wherein the amount of milk powder may be at least 2% w/w, preferably at least 3% w/w in the foodstuff. It is preferably less than 20% w/w, more preferably less than 15% w/w. The amount of milk.may be less than 80% w/w, preferably less than 75% w/w. Another ingredient that may be common to a. number of foodstuffs is sugar (e.g. sucrose) and the method may involve contacting the first food ingredient with sugar wherein the amount of sugar is at least 2% w/w, preferably at least 3% w/w, more. preferably at least 3.5% w/w. The amount may be less than 15% w/w, preferably less than 13% w/w.

It has been found that the edible fungi can act as a fat mimetic and, accordingly, the amount of fat and/or fat containing ingredients added can be reduced. More particularly, it has been found that the edible fungal particles promote the creamy mouthfeel typically associated with fat.

The foodstuff prepared in the method may be a dessert (e.g. a chilled dessert) for example a mousse, crème caramel or chocolate dessert (or the like). More generally, the foodstuff may be a hot-fill, cold-fill, demouldable, non-demouldable, aerated or non-aerated dessert.

The foodstuff prepared in the method may be a yoghurt. Preparation of a yoghurt may involve contacting, suitably with mixing, the first food ingredient with sugar, milk (e.g. skim milk) and/or milk (e.g. skim milk) powder and water. The total protein content in the yoghurt may be at least 2% w/w, preferably at least 3% w/w, more preferably at least 4% w/w, especially at least 5% w/w. The amount may be less than 10% w/w, preferably less than 8% w/w, more preferably less than 6% w/w. After contact and mixing of the ingredients, a culture may be added and the mixture incubated. Thereafter, the mixture may be sheared, prior to the optional addition of flavouring. Advantageously, less than 1% w/w suitably less than 0.5% w/w, preferably less than 0.2% w/w, more preferably less than 0.1% w/w, especially substantially no additional polysaccharide and/or gelatin stabilisers are added to the yoghurt in the method.

The foodstuff prepared in the method may be an ice-cream type dessert. Preparation of a said dessert may involve contacting, suitably with mixing (e.g. with a high shear mixer), the first food ingredient with sugar, glucose syrup, skim milk powder and oil (e.g. palm oil) and optionally one or more stabilisers/emulsifiers. After further treatment, the mixture may be whipped and frozen.

The foodstuff prepared in the method may be a milk drink. Preparation of such a drink preferably involves the use of said edible fungal particles in combination with milk (e.g. skim milk) paste or powder. For example, the first food ingredient may comprise dry particles comprising skim milk and fungi. The combination is preferably contacted with other ingredients and milk and/or water added as required with suitable mixing.

The foodstuff or second food ingredient prepared in the method may be a reconstitutable product, for example a reconstitutable fluid such as a drink and/or soup. In the method, a said solid first food ingredient is preferably mixed with other dry materials. Preferably, said solid first food ingredient (which preferably consists essentially of substantially dry edible fungal particles) is mixed with skim milk powder. The mixture (suitably including relevant other ingredients) may be packaged in a substantially air and fluid tight receptable for example a sealed sachet. In the case of a drink, the other ingredients may include a sweetening means and/or a flavour means and/or a stabiliser. In the case of soup, the other ingredients may include flavouring means and/or a stabiliser.

In another embodiment, a foodstuff for consumption or a second food ingredient may be a solid. The method of the fourth aspect may include making said solid in a substantially predetermined shape, for example as pellets or bullets. Said solid may be formed in a process using heat and/or pressure. It is especially preferred that the solid is formed in a process which involves the application of heat to a formulation which includes said first food ingredient. In the process, the formulation may be heated to a temperature of at least 30° C., preferably at least 50° C., more preferably at least 70° C., especially at least 80° C. The temperature may be less than 200° C., preferably less than 120° C. The method of the fourth aspect may involve extruding a mixture comprising said first food ingredient and at least one other ingredient.

In general terms, said mixture may include at least 4.5% w/w, preferably at least 9% w/w of said first food ingredient especially wherein said first food ingredient includes at least 80% w/w, 90% w/w or 95% w/w of edible fungal particles. Advantageously, the method may be used to prepare foodstuffs or second food ingredients having relatively high levels of edible fungi coupled with acceptable taste and Theological properties. Thus, the method may be used to prepare foodstuffs or second food ingredients of 15% w/w or more, 20% w/w or more, and even 25% w/w or more of edible fungi. The amount of edible fungi may be less than 40% w/w, suitably less than 35% w/w.

Said at least one other ingredient may include a carbohydrate and/or protein. Examples of a carbohydrate are starch or sugar (e.g. sucrose). Said at least one ingredient may be a flour.

In one example, said first food ingredient may be mixed with water in conjunction with a starch and/or sugar and the mixture extruded to produce solid products, for example having a volume of at least 15 mm³, preferably at least 30 mm³. The volume may be less than 15 cm³. In another example, the first food ingredient may be mixed with a cereal, for example maize grits, and water. The level of water used can be selected to alter the density of an extruded product formed. A porous product can be produced as water flashes off during extrusion; the more water that flashes off, the lower the density and/or the greater the porosity. The water content in the mixture prior to extrusion may be at least 5% w/w, preferably at least 10% w/w, more preferably at least 15% w/w. The amount of water is preferably less than 30% w/w.

Solid products of the type described may be for consumption (e.g. human consumption) optionally after applying flavouring. They may be snack foods or breakfast cereals. Alternatively, solid products as described may comprise second food ingredients which may be mixed with other ingredients to prepare foodstuffs for consumption. For example, a said second food ingredient may be mixed with fruits or other fibrous materials to prepare a breakfast cereal or a said second food ingredient could be incorporated into a solid product, for example a confectionery bar. Thus, the method of the fourth aspect includes the optional step of mixing a second food ingredient prepared with another ingredient to prepare a foodstuff for consumption.

In a further embodiment wherein a solid foodstuff is prepared, the first food ingredient may be contacted with other ingredients, for example, semolina, thereby to make a pasta. A pasta prepared may have at least 10% w/w, preferably at least 15% w/w, of edible fungi on a dry matter basis. The amount of said fungi may be less than 30% w/w, preferably less than 25% w/w.

According to a fifth aspect of the invention, there is provided a foodstuff for consumption or a second food ingredient, suitably as described according to the fourth aspect, which comprises edible fungi.

The ratio of the % w/w of egg albumin powder to the % w/w of edible fungi in said foodstuff or second food ingredient is suitably less than 0.1, preferably less than 0.05, more preferably less than 0.01. Preferably, the foodstuff or second food ingredient includes substantially no albumin powder and/or no egg albumin at all.

Said foodstuff or second food ingredient may be an extrudate. Thus, the invention extends to an extruded foodstuff which comprises edible fungi.

Said foodstuff may be a dairy product as described herein.

Said foodstuff or second food ingredient may be pasta.

According to a sixth aspect of the invention, there is provided the use of an edible fungus in the preparation of a foodstuff, especially an extruded foodstuff or pasta (suitably so that said edible fungus not solely an extract thereof is,present in the foodstuff), for the treatment of joint mobility disorders; for reducing fat uptake; for lowering cholesterol; for immune function stimulation; as a pre-biotic and/or for affecting satiety.

According to a seventh aspect of the invention, there is provided a method of preparing a foodstuff, especially an extruded foodstuff or pasta, having at least 300 mg (preferably at least 350 mg and suitably less than 600 mg) of N-acetyglucosamine per 100 g of foodstuff; at least 600 mg (preferably at least 750 mg and suitably less than 1300 mg) of β-glucan per 100 g of foodstuff, the method comprising contacting edible fungi with other ingredients of said foodstuff.

According to an eighth aspect, there is provided a foodstuff, having at least 300 mg of N-acetylglucosamine and at least 600 mg of β-glucan per 100 g of foodstuff.

Any feature of any aspect of any invention or embodiment described herein may be combined with any feature of any aspect of any other invention or embodiment described herein mutatis mutandis.

Specific embodiments of the invention will now be described, by way of example, with reference to the accompanying drawings, in which:

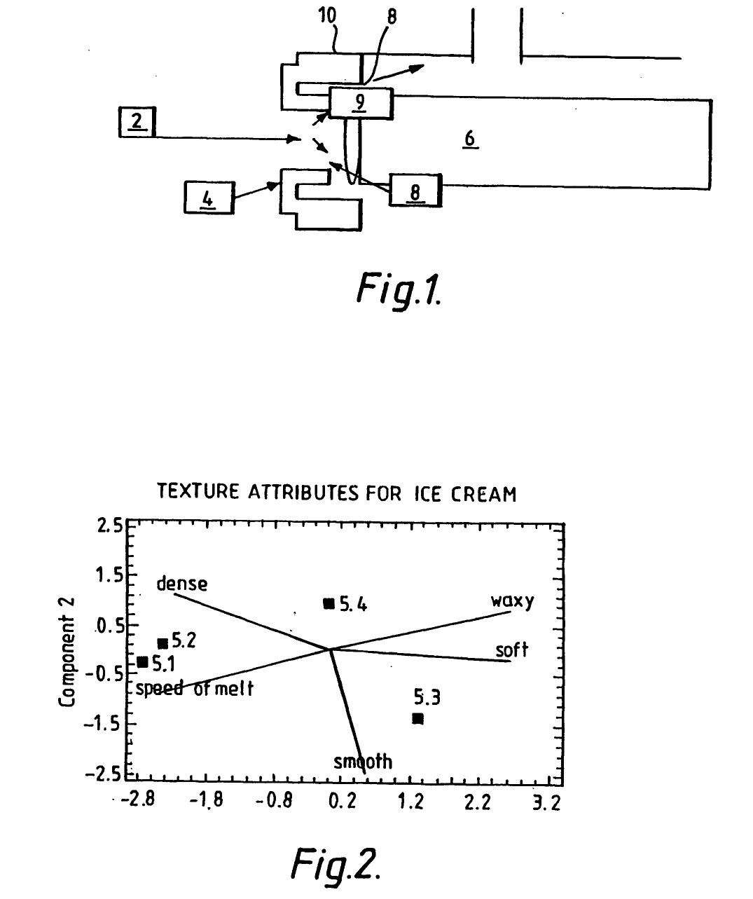

FIG. 1 is a schematic representation of an APV Lab 2000 homogeniser; and

FIG. 2 is a principal component plot describing the attributes of an ice-cream type dessert.

The following products are referred to hereinafter:

mycoprotein paste—refers to a visco-elastic material comprising a mass of edible filamentous fungus derived from Fusarium venenatum A3/5(formerly classified as Fusarium graminearum Schwabe) (IMI 145425; ATCC PTA-2684 deposited with the American type Culture Collection, 12301 Parklawn Drive, Rockville Md. 20852) and treated to reduce its RNA content to less than 2% by weight by heat treatment. Further details on the material are provided in WO96/21362 and WO95/23843. The material may be obtained from Marlow Foods Limited of Stokesley, U.K. It comprises about 25 wt % solids made up of non-viable RNA reduced fungal hyphae of approximately 400-750 μm length, 3-5 μm in diameter and a branching frequency of 2-8 tips per hyphal length.

Hobart mixer—a beater mixer with a planetary mixing action made by Hobart Corporation of Troy Ohio, U.S.A.

Silverson L4RT high shear blender—obtained from Silverson Machines Ltd of Bucks, England.

APV Lab 2000 homogeniser—supplied by APV Homogenisers AS of Denmark. It is a research and development tool for exploring homgenisation at feed stream pressures of up to 2000 bar.

Crepaco homogeniser—supplied by APV Crepaco and capable of operating at a maximum feed stream pressure of 350 bar.

Kestner Lab Spray Dryer—Spray Dryer No 5 obtained from Kestner Evaporator & Engineer Co of London, England.

Stefan Mixer—supplied by Stephan Nahrungsmittel und Verfahrens Technik of Germany. For this mixer, the mixing head is based on the speed of rotation of selected blade designs.

Modified starch (National Starch Coarse Instant Clear Jel)—a pre-gelatinised modified starch used as a thickener obtained from National Starch.

Lactobacillus delbrueckii ssp bulgaricus, Streptococcus themophillus, Lactobacillus acidophilus and Bifidobacterium—a yoghurt starter culture obtained from Rhodia Foods, Stockport, U.K.

### EXAMPLE 1

### The Influence of Dispersion Time and Mixing Methodology on Dispersion Efficiency

Mycoprotein paste was added to shop-bought skim milk at 25% w/w and left to ‘hydrate’ further for 5, 15 and 30 minutes. After each time interval the ‘dispersion’ was filtered using a coarse muslin cloth and the amount of residual solids quantified as a measure of degree of dispersion. In addition, at each time interval one batch of the dispersion was mixed for 4 minutes using a Hobart mixer on setting number 4 whilst a second batch was mixed using a Silverson L4RT high shear blender using a slotted disintegrating head at 8000 rpm. In each case the dispersion efficiency was measured on the basis of residual solids in the muslin cloth.

Results are provided in Table 1.

TABLE 1

| | TIME | % |
|---|---|---|
| PROCESS | (min) | RESIDUAL SOLIDS |
| NO TREATMENT | 5 | 95% |
| | 15 | 94% |
| | 30 | 94% |
| MIXING USING | 5 | 20% |
| SILVERSON MIXER | 15 | 15% |
| | 30 | 8% |
| MIXING USING | 5 | 60% |
| HOBART MIXER | 15 | 42% |
| | 30 | 30% |

The experiments illustrate that it is beneficial to hydrate the mycoprotein paste prior to dispersion by agitation. Additionally, it is beneficial to use a high shear mixer (e.g. Silverson). Similar benefits were found for dispersions made in either 3% w/w caseinate solution or 3% w/w whey protein concentrate instead of skim milk. In general terms, any protein-containing aqueous liquid may be used.

Unless otherwise stated herein, when a formulation comprising mycoprotein paste and skim milk or water is used, the paste is allowed to hydrate for 30 minutes prior to subsequent use.

### EXAMPLE 2

### Investigations Relating to Homogenisation

The basic principles of homogenisation will be described with reference to FIG. 1. Unhomogenised product 2 enters the valve seat 4 at low viscosity and low pressure. As the product flows through an adjustable close clearance area between a valve 6 and seat 4, there is a rapid increase in velocity with a corresponding decrease in pressure. This intense energy transition occurs in microseconds and produces turbulent three dimensional mixing layers that disrupt particles at the discharge from the gap 8. The homogenised product (9) impinges on an impact ring 10 and exists at a pressure sufficient for movement to the next processing stage. The acceleration of the liquids through the gap also produces a pressure drop to below the vapour pressure of some components. This may lead to implosive forces being generated.

(a) Effect of homogenisation temperature on flowrate through homogeniser

The effect of homogenisation temperature on flow rate through the APV Lab 2000 homogeniser of the mycoprotein/skim milk formulation described in Example 1 was assessed over a range of pressures and the results are provided in Table 2 wherein “1^{st} stage” and “2^{nd} stage” pressure refer to the pressure of the formulation when entering through valve seat 4 and the subsequent downstream pressure (the pressure measured at the exit of the valve assembly) respectively.

TABLE 2

| | 2^{nd} stage | | |
|---|---|---|---|
| Temperature ° C. | pressure (bar) | 1^{st} stage pressure (bar) | Q (kg/h) |
| 20 | 0 | 0 | 15 |
| 20 | 90 | 500 | 8 |
| 20 | 230 | 1210 | 6 |
| 20 | 350 | 1600 | 5.4 |
| 50 | 90 | 500 | 11 |
| 50 | 230 | 1210 | 10 |
| 50 | 350 | 1600 | 10 |
| 70 | 90 | 500 | 8 |
| 70 | 230 | 1210 | 6.6 |
| 70 | 350 | 1600 | 6 |

It will be noted from Table 2 that the optimum flow rate is achieved at about 50° C.

(b) Effect of dispersion and/or homogenisation processes on hyphal aspect ratio of the mycoprotein

Typically, mycoprotein hyphae are 400-750 μm in length with a diameter of 3-5 μm. The effect of a range of dispersion and/or homogenisation processes on the measured hyphal lengths of mycoprotein filaments was investigated. Details of processes used and the results are provided in Table 3a. In each case, a formulation was prepared of mycoprotein paste (25% w/w) and water or skim milk, with the paste being allowed to hydrate for 30 minutes prior to the subsequent processes described in the Table.

The assessment of hyphal lengths in a sample of mycoprotein is undertaken as follows: Light microscope preparations are made from the sample and light microscope images captured and processed as greyscale bitmaps. The images are saved on 8-bit greyscale bitmaps to a resolution of 764-576 pixels. The magnification was determined as 0.81 micron/pixel using a static graticule and corresponding to a field of view of 0.62×0.47 mm for each image. Dedicated software was written to analyse the images.

TABLE 3a

| | | | Standard | |
|---|---|---|---|---|
| Example | | Mean | deviation | Median |
| No | Process | (um) | (um) | (um) |
| 2a | The formulation of mycoprotein paste in water was dispersed using a | 34.1 | 66.1 | 7.3 |
| | Silverson blender as described in Example 1 | | | |
| 2b | The formulation of mycoprotein paste in water was dispersed using a | | | |
| | Silverson blender as described in Example 1 followed by homogenisation | | | |
| | using the Crepaco homogeniser at 270 bar | | | |
| 2c | The formulation of mycoprotein paste in water was dispersed using a | 18.3 | 20.5 | 12.1 |
| | Silverson blender as described in Example 1 followed by homogenisation | | | |
| | using the Crepaco homogeniser at 270 bar followed by homogenisation using | | | |
| | the APV Lab 2000 homogeniser at an inlet pressure of 750 bar and a second | | | |
| | stage pressure of 75 bar | | | |
| 2d | The formulation of mycoprotein paste in water was dispersed using a | 15.7 | 15.7 | 11.3 |
| | Silverson blender as described in Example 1 followed by homogenisation | | | |
| | using the Crepaco homogeniser at 270 bar followed by homogenisation using | | | |
| | the APV Lab 2000 homogeniser at an inlet pressure of 1500 bar and a | | | |
| | second stage pressure of 350 bar. | | | |
| 2e | The formulation of mycoprotein paste in skim milk was dispersed using a | 50.8 | 53.1 | 31.5 |
| | Silverson blender as described in Example 1. | | | |
| 2f | The formulation of mycoprotein paste in skim milk was dispersed using a | 26.5 | 52.2 | 13.7 |
| | Silverson blender as described in Example 1 followed by homogenisation | | | |
| | using the Crepaco homogeniser at 270 bar. | | | |
| 2g | The formulation of mycoprotein paste in skim milk was dispersed using a | 15.9 | 14.9 | 11.3 |
| | Silverson blender as described in Example 1 followed by homogenisation | | | |
| | using the Crepaco homogeniser at 270 bar followed by homogenisation using | | | |
| | the APV Lab 2000 homogeniser at an inlet pressure of 750 bar and a second | | | |
| | stage pressure of 75 bar. | | | |
| 2h | The formulation of mycoprotein paste in skim milk was dispersed using a | 15.4 | 13.5 | 11.3 |
| | Silverson blender as described in Example 1 followed by homogenisation | | | |
| | using the Crepaco homogeniser at 270 bar followed by homogenisation using | | | |
| | the APV Lab 2000 homogeniser at 1500 bar. | | | |

It will be noted from Table 3a that the Silverson and/or the APV or Crepaco homogenisers can be used to reduce the aspect ratio (length/diameter) of the mycoprotein filaments significantly—from 90 to about 10 for the Silverson; to about 5 in the case of the Crepaco homogeniser; and to about 3 in the case of the APV homogeniser (assuming the mean native filament length to be 450 μm and 5 μm in diameter).

### EXAMPLE 3

### Spray Drying of Homogenised Dispersion of Mycoprotein

Dispersions of mycoprotein paste in water (Example 3a) or skim milk (Example 3b) were prepared as described in Example 1 except that each dispersion was made at 30 % w/w and was homogenised using an APV Crepaco homogeniser at 270 bar before spray drying. Spray drying was carried out using a Kestner Lab Spray Drier at 190° C. inlet and 90° C. outlet temperature and an evaporation rate of 25 Kg/L. In addition, a further sample (Example 3c) was prepared by further homogenising the aforementioned sample in skim milk on the APV Lab 2000 machine (using inlet pressure of 1500 bar and outlet pressure of 300 bar) before spray drying as described. In a further study (Example 3d) after homgenisation of the 30% w/w dispersion in skim milk, the dispersion was adjusted to a titratable acidity (TA) of 0.15 using food grade sodium hydroxide. This gave a pH of about 6.8. Disodium hydrogen phosphate was also added at 2 g/kg dispersion. The dispersion was then evaporated using a three effect evaporator from about 14% w/w total solids to 28% w/w. This more concentrated dispersion was spray dried as before.

The typical morphology of the spray dried material was assessed as described in Example 2(b) and the results are provided in Table 3b. The spray dried material may include up to 5% w/w of water.

TABLE 3b

| | | | Standard | | 25^{th} | 75^{th} | Mean from |
|---|---|---|---|---|---|---|---|
| Example | | Mean | deviation | Median | percentile | percentile | log scale |
| No | Summary of Process | (um) | (um) | (um) | (um) | (um) | (um) |
| 3a | Mycoprotein in water | 29.3 | 36.8 | 15.4 | 8.9 | 32.9 | 17.3 |
| | homogenised at 270 bar | | | | | | |
| | and then spray dried. | | | | | | |
| 3b | Mycoprotein in skim | 23.6 | 37.2 | 12.1 | 7.3 | 21.8 | 13.5 |
| | milk homogenised at | | | | | | |
| | 270 bar and then spray | | | | | | |
| | dried | | | | | | |
| 3c | Mycoprotein in skim | 14.9 | 12.3 | 12.1 | 8.1 | 17.8 | 11.6 |
| | milk homogenised at | | | | | | |
| | 270 bar, then at 1500 | | | | | | |
| | bar and then spray | | | | | | |
| | dried. | | | | | | |
| 3d | Mycoprotein in skim | 18.1 | 17.2 | 19.2 | 17.6 | 22.0 | 17.2 |
| | milk, TA adjusted to | | | | | | |
| | 0.15 then homogenised | | | | | | |
| | at 350 bar, evaporated | | | | | | |
| | to 28% w/w solids and | | | | | | |
| | spray dried. | | | | | | |

### EXAMPLE 4

### Preparation and Evaluation of Yoghurts

Batches of yoghurt were prepared such that about 5% w/w of mycoprotein solids was present in the final product. One yoghurt (Example 4a) was included as a control since it included no mycoprotein; the others included reconstituted spray dried mycoprotein.

Details on the preparation of the batches are provided in Table 4.

TABLE 4

| Example No | Description |
|---|---|
| 4a | Control with protein at 5.5% (no mycoprotein) |
| 4b | Yoghurt prepared by reconstituting spray dried |
| | powder so as to give an equivalent of 20% w/w native |
| | paste in the finished product. The powder was |
| | prepared by spray drying a homogenised formulation |
| | of mycoprotein and skim milk as described in Example |
| | 2f using the spray drying method described in |
| | Example 3. |
| 4c | Yoghurt were prepared as described in Example 4b |
| | except that the powder was prepared using an APV Lab |
| | 2000 homogeniser at 1750 bar. |
| 4d | Yoghurt prepared as described in Example 4b except |
| | that powder was prepared as described in Example 3d. |

All yoghurts were prepared as a base mix to which strawberry fruit preparation obtained from Aptunion Fruit Preparation of Worcester, England was added. The base mixes included sugar, skim milk, skim milk powder and water at levels described in Table 5, with the total protein content in each case being about 5.5 % w/w. The base mix was prepared by mixing using a Braun™ hand blender for 30 seconds.

TABLE 5

| | | Paste/ | | | | |
|---|---|---|---|---|---|---|
| | | spray | Skim | Skim | | |
| | Mycoprotein/ | dried | Milk | Milk | Sugar | |
| Batch | protein | powder | (% | Powder | (% | Water |
| No | used | (% w/w) | w/w) | (% w/w) | w/w) | (% w/w) |
| 4.1 | 4a | 0 | 80 | 8.17 | 4 | 7.83 |
| 4.2 | 4b | 10.4 | 20 | 2.57 | 4 | 63.03 |
| 4.3 | 4c | 10.4 | 20 | 2.57 | 4 | 63.03 |
| 4.4 | 4d | 10.4 | 20 | 2.57 | 4 | 63.03 |

The base mixes prepared were heated with agitation to 90° C. for 10 minute and then cooled rapidly to 42° C. A mixed thermophilic blend of culture was added at a rate of 0.1 units per litre where 1 unit=about 1 gram of freeze dried culture of Lactobacillus delbrueckii ssp bulgaricus, Streptococcus themophillus, Lactobacillus acidophilus and Bifidobacterium. The mixes were incubated at 42° C. for approximately 6 hours or until the pH had dropped from 6.8 to 4.55. At this end point, the incubating mixes were sheared using a hand held Braun™ high shear blender. The sheared mixes were then cooled to <20° C. where fruit preparation was added at 15% (w/w) and the mixes potted and lidded with cooling to <5° C. The pots were equilibrated for six days prior to evaluation.

No additional polysaccharide or gelatin stabilisers were used. Finished product fat levels for Batches 4.2 and 4.3 were <0.5% (w/w).

Samples of each yoghurt were evaluated as described in Example 2(b) to assess the geometry of the mycoprotein filaments contained therein and the results are provided in Table 6.

TABLE 6

| | | | | | | Mean |
|---|---|---|---|---|---|---|
| | | Standard | | 25^{th} | 75^{th} | from log |
| Batch | Mean | deviation | Median | percentile | percentile | scale |
| No | (μm) | (μm) | (μm) | (μm) | (μm) | (μm) |
| 4.2 | 15.0 | 29.7 | 8.1 | 4.8 | 12.1 | 7.8 |
| 4.3 | 16.0 | 27.8 | 8.1 | 4.8 | 15.4 | 9.0 |
| 4.4 | 17.0 | 24.7 | 9.1 | 7.8 | 12.1 | 9.8 |

The yoghurts prepared were evaluated by a panel of assessors trained in sensory descriptive analysis. A vocabulary was agreed during pretrial training sessions with this panel such that textural attributes for the yoghurts could be assessed and quantified. The scores for attributes assessed and overall score for acceptability are provided in Table 7a. The higher the value for acceptability, the more acceptable the product.

TABLE 7a

| Batch | | | | | | | |
|---|---|---|---|---|---|---|---|
| No | | | | | | | |
| prepa- | | | | | Water | | Accepta- |
| ration | Smooth | Grainy | Soft | Airy | y | Chalky | bility |
| 4.1 | 9 | 2 | 2 | 8 | 7 | 2 | 5 |
| 4.2 | 6 | 6 | 8 | 9 | 5 | 9 | 3 |
| 4.3 | 8 | 4/5 | 8 | 8 | 5 | 8 | 5 |
| 4.4 | 9 | 1 | 7 | 7 | 5 | 1 | 6 |

It should be appreciated from the examples of the finished products that the mycoprotein appears to behave as a fat mimetic importing good mouth feel. Further, for yoghurts, it is not essential to use additional polysaccharides or gelatin to promote texture at the very low fat levels found. However, the technologist is able to exploit textural synergies that exist between the mycoprotein and available stabilisers in order to create the texture that is desired for the commercial positioning of the product.

The adjustment of TA in Batch No. 4.4 was felt to improve the eating quality of the finished product and this may be due to minimising the calcium bridging between casein micelles during spray drying. This might otherwise promote a more grainy texture in subsequent finished products. It is believed that this step is important alongside suitable changes to the aspect ratio of the hyphae. At hyphal aspect ratios in excess of around 40, rehydration of the powder leads to progressive unfolding of the hyphae which had previously been “locked away” within the dried milk protein. As the hyphae unfold then an entwined network of hyphae is set up resulting in undesirable textures for products such as yoghurt. This effect may not be so important for frozen deserts, where the creation of this entangled network can help improve the melt-down characteristics of the frozen dessert.

FIG. 1 exemplifies the nature of the co-dried skim milk and mycoprotein.

As described above, the mycoprotein paste content in the products was 20% w/w and/or the products included about 5% w/w of paste solids. At this level, it is believed sufficient glucosamine, chitin and β-Glucan can be delivered to have positive health benefits. For example, 1-5 g/day of glucosamine, 3-10 mg/day of β-glucans, 1 g/day of chitin and a ratio of linoleic acid to linolenic acid in the range 4.1 to 10.1 may be desirable

Table 7b details nutrient levels supplied by mycoprotein in a 150 g pot of yoghurt of various paste inclusions (%) and paste g wet wt.

TABLE 7b

| Paste | Paste | Nutrient from mycoprotein | | | | | | |
|---|---|---|---|---|---|---|---|---|
| Inclusion | (g wet | Glucosamine | Chitin | B-Glucan | Fibre | Fat | | |
| (% w/w) | wt) | (mg) | (mg) | (mg) | (g) | (g) | w-3-lin (mg) | w-6-lin (mg) |
| 10 | 15 | 300 | 300 | 600 | 0.900 | 0.003 | 60.0 | 206 |
| 15 | 22.5 | 450 | 450 | 900 | 1.350 | 0.005 | 90.0 | 309 |
| 20 | 30 | 600 | 600 | 1,200 | 1.800 | 0.006 | 120.0 | 411 |
| 25 | 37.5 | 750 | 750 | 1,500 | 2.250 | 0.008 | 150.0 | 514 |
| 30 | 45 | 900 | 900 | 1,800 | 2.700 | 0.009 | 180.0 | 617 |

As will be appreciated from the above, preparing yoghurts in the manner described enables advantageously high levels of important nutrients to be supplied whilst not affecting significantly (and in some cases improving) the eating quality of the yoghurt.

### EXAMPLE 5

### Preparation and Evaluation of Ice-Cream Type Desserts

Batches of ice-cream type dessert were prepared such that a mycoprotein paste content of 20% w/w was present in the final product. This concentration delivers about 5% w/w of paste solids. One batch was included as a control since it included no mycoprotein; the others included reconstituted spray dried mycoprotein. Details of the batches and particularly the preparation of the mycoprotein in the batches are provided in Table 8.

TABLE 8

| Example No | Description |
|---|---|
| 5a | Control without extra skim milk to compensate |
| | for paste (no mycoprotein) |
| 5b | Control with extra skim milk to compensate for |
| | paste (no mycoprotein) |
| 5c | Dessert prepared by reconstituting spray dried |
| | powder so as to give an equivalent of 20% w/w |
| | native paste in the finished product. The |
| | powder was prepared by spray drying a |
| | homogenous formulation of mycoprotein and skim |
| | milk as described in Example 2f using the spray |
| | drying method described in Example 3. |
| 5d | Dessert prepared as described in Example 5c |
| | except that the powder was prepared as |
| | described but using an APV Lab 2000 homogeniser |
| | at 1750 bar. |

All desserts were prepared as having finished product fat levels of 4.5% w/w and 31% w/w total solids. A summary of the ingredients is provided in Table 9.

TABLE 9

| | Myco- | | Skim | | | Palm | |
|---|---|---|---|---|---|---|---|
| | protein/ | Aqueous | Milk | Glucose | Sugar | oil | Stabiliser |
| Batch | protein | addition | Powder | syrup | % | % | Emulsifier |
| No | used | % w/w | % w/w | % w/w | w/w | w/w | % w/w |
| 5.1 | 5a | 69 | 9 | 5 | 12 | 4.5 | 0.5 |
| | | (water) | | | | | |
| 5.2 | 5b | 63.8 | 14.2 | 5 | 12 | 4.5 | 0.5 |
| | | (water) | | | | | |
| 5.3 | 5c | 10.4 # | 3.6 | 5 | 12 | 4.5 | 0.5 |
| 5.4 | 5d | 10.4 # | 3.6 | 5 | 12 | 4.5 | 0.5 |

# 10.4% w/w powder (codried skim milk and mycoprotein) plus 64% w/w water giving a total of 74.4% w/w water and powder

The homogenised dispersion of mycoprotein in water (or reconstituted powder) was heated to 50° C. along with the dry ingredients, glucose syrup and oil. This heated mix was then mixed using the Silverson at 8000 rpm, allowing the temperature to increase to 80° C. and holding for 30 seconds prior to rapid cooling to below 10° C. This mix was then ‘aged’ for four hours before whipping and freezing using a Gaggio laboratory ice cream maker. Overrun was measured.

Samples of each dessert were evaluated as described in Example 2(b) to assess the geometry of the mycoprotein filaments contained therein and the results are provided in Table 10.

TABLE 10

| | | Standard deviation | |
|---|---|---|---|
| Batch No | Mean (μm) | (μm) | Median (μm) |
| 5.3 | 22.2 | 30.1 | 12.1 |
| 5.4 | 19.2 | 17.7 | 13.7 |

The desserts prepared were evaluated by a panel of assessors trained in sensory descriptive analysis as for Example 4 above. The raw scores obtained were converted into a principal components plot which is provided in FIG. 2.

Acceptability scores for the desserts are shown in Table 11 on a scale wherein 0 represents “acceptable no defects” up to 3 which represents “unacceptable”. Table 11 shows each to have a score of less than 1 and, therefore, each is deemed “acceptable” within the quality standards used by the trained sensory panellists.

TABLE 11

| Batch No | Score |
|---|---|
| 5.1 | 0 |
| 5.2 | 0 |
| 5.3 | 0.9 |
| 5.4 | 0.2 |

As will be appreciated, the mycoprotein replaces fat in the dessert and yet the eating quality of the dessert is acceptable. Thus, the mycoprotein appears to act as a fat mimetic.

Additionally, referring to FIG. 2, the controls (Examples 5a and 5b) are separated from those containing mycoprotein chiefly by speed of melt (in the mouth). Thus, the mycoprotein appears to affect the freeze-thaw characteristics of the dessert.

As for the yoghurt, the mycoprotein paste content in the desserts was 20% w/w and/or the desserts included 5% w/w of paste solids. The nutrient levels may be calculated based on details in Table 7b on the basis of, for example two conventional scoops (about 150 ml or 100 g)

Preparing desserts in the manner described enables advantageously high levels of important nutrients to be supplied whilst not affecting significantly the eating quality.

### EXAMPLE 6

### Preparation and Evaluation of Flavoured Milk Drinks

Batches of flavoured milk drink were prepared such that a mycoprotein paste content of 18.75% w/w was present in the final product. This concentration delivers about 4.70% w/w of paste solids. One drink (Example 6a) was included as a control since it included no mycoprotein; the others included reconstituted spray dried mycoprotein.

Details on the batches and particularly the presentation of mycoprotein in the batches are provided in Table 12.

TABLE 12

| Example No | Description |
|---|---|
| 6a | Control using skim milk (no mycoprotein) |
| 6b | Flavoured milk drink prepared by |
| | reconstituting spray dried powder so as to |
| | give an equivalent of 20% w/w native paste |
| | in the final product. The powder was |
| | prepared by spray drying a homogenous |
| | formulation of mycoprotein and skim milk as |
| | described in Example 2f using the spray |
| | drying method described in Example 3. |
| 6c | Flavoured milk drink prepared as described |
| | in Example 6b except that the powder was |
| | prepared as described but using an APV Lab |
| | 2000 homogeniser at 1750 bar. |
| 6d | Flavoured milk drink made as described in |
| | Example 6b except that the titratable |
| | acidity (TA) of the dispersion was adjusted |
| | and disodium hydrogen phosphate added as |
| | described in Example 3d, followed by spray |
| | drying and preparation of the drink. |

A summary of the ingredients in the milk drinks is provided in Table 13.

TABLE 13

| | | Paste/spray | | Skim Milk | Skim Milk | | | Flavour | |
|---|---|---|---|---|---|---|---|---|---|
| | Mycoprotein/ | dried | Skim | with | with | | | and | |
| Batch | protein | power | Milk | Paste | power | Sugar | Stabiliser | colour | Water |
| No | used | % w/w | (% w/w) | (% w/w) | (% w/w) | (% w/w) | (% w/w) | (% w/w) | (% w/w) |
| 6.1 | 6a | 0 | 93.75 | 0 | 0 | 6 | 0.03 | 0.24 | 0 |
| 6.2 | 6b | 9.04 | 0 | 0 | 2.41 | 6 | 0.03 | 0.24 | 82.28 |
| 6.3 | 6c | 9.04 | 0 | 0 | 2.41 | 6 | 0.03 | 0.24 | 82.28 |
| 6.4 | 6d | 9.04 | 0 | 0 | 2.41 | 6 | 0.03 | 0.24 | 82.28 |

Batch number 6.1 was prepared by adding sugar, stabiliser, colour and flavour to skim milk. The mixture was then heated up to 95° C., held for 1 minute and then cooled to less than 10° C.

Batch numbers 6.2, 6.3 and 6.4 were prepared by reconstituting the skim milk and paste powder in water then adding sugar, stabiliser, colour and flavour. The mixtures were then heated up to 95° C., held for 1 minute and then cooled to less than 10° C.

The milk drinks were assessed by a panel as described in the preceding examples. Results are shown in Table 14a.

TABLE 14a

| Batch No | Drinking Quality |
|---|---|
| 6.1 | Thin body lacking in creaminess; good colour and flavour. |
| 6.2 | Good colour and flavour but overall body a |
| | little thicker and slightly pulpy relative to |
| | the control. |
| 6.3 | Good colour and flavour, creamy and with good |
| | body. |
| 6.4 | Excellent colour and flavour, creamy with a |
| | good body. |

The mycoprotein replaces fat in the drink and the eating quality is still acceptable. Thus, the mycoprotein appears to act as a fat mimetic. In addition, the adjustement of TA (Batch 6.4) and the addition of disodium hydrogen phosphate prior to drying also improves the drinking quality. This may be due to the minimisation of calcium bridging between casein micelles.

The mycoprotein paste content in the drinks was 18.75% w/w and/or the drinks included 4.70 w/w of paste solids. The nutrient levels may be calculated based on details in Table 7b.

### EXAMPLE 7

### Preparation and Evaluation of Flavoured Ambient Stable Reconstitutable Drinks

The spray dried mycoprotein and skim milk powder of Example 6d was mixed with sugar, flavour and stabiliser in order to produce an ambient stable reconstitutable drink. All powders were packed into foil sealed sachets to allow the consumer to open and reconstitute with either skim milk or water to give 250 ml servings of a flavoured drink.

A summary of the examples of the types of formulations that can be produced is given in Table 14b

TABLE 14b

| | | | Paste/ | Skim milk | | | | Flavour | Acesulfame- | Serving size |
|---|---|---|---|---|---|---|---|---|---|---|
| Batch | | Mycoprotein/protein | Spray dried | powder | Sugar | Creamer | Stabiliser | and colour | k/ | (powder |
| No | Description | used | power % w/w | (% w/w) | (% w/w) | (% w/w) | (% w/w) | (% w/w) | Aspartame | grams) |
| 7.1 | Milk mixable | 6d | 50 | 0 | 41 | 5.6 | 0.3 | 3.1 | 0 | 45 g |
| 7.2 | Water mixable | 6d | 18 | 42 | 29 | 9 | 1 | 1 | 0 | 57 g |
| 7.3 | Milk mixable, | 6d | 63.07 | 0 | 0 | 30 | 0.6 | 6 | 0.33 | 16.6 g |
| | sugar free | | | | | | | | | |
| 7.4 | Milk mixable | 6d | 76.87 | 15 | 0 | 0 | 0.4 | 7.4 | 0.33 | 13.6 |
| | sugar free, no | | | | | | | | | |
| | creamer | | | | | | | | | |

Table 14b shows that it was possible to prepare products to deliver from 5 to 10 g of mycoprotein solids per serving. Servings may be sugar free and can be prepared with water or chilled skim milk. The choice of finished product design is a function of the product positioning in the market. This is illustrated by the above.

All of the products in Table 14b were assessed by trained sensory panellists and found to be of good drinking quality. Additionally, product 6.4 was independently compared to a leading brand shake and found to be preferred over the shake.

### EXAMPLE 8

### Preparation of Extruded Materials

### EXAMPLE 8.1

### Preparation of Mycoprotein Solids

Frozen mycoprotein paste was freeze dried and milled to a particle size nominally of less than 100 microns. The freeze dried material has a moisture content of about 3% w/w.

### EXAMPLE 8.2

### Preparation of Mycoprotein Pellets

Mixtures of powder from Example 8.1, wheat starch, sugar and water were prepared by simple mixing as described in Table 15a. These mixtures were each extruded using an APV MPF 50 twin-screw extruder in Configuration 1 arranged to produce pellets (Configuration 2 referred to hereinafter is arranged to produce “puffed” products). The configurations are summarised below.

| Configuration 1 | Configuration 2 |
|---|---|
| ¼″ spacer | 10″ feed screws |
| 10″ Feed screw | 7 × 45° forwarding |
| 8 * 30 forwarding paddles | Paddles |
| 3″ single lead screw | Feed screws |
| 2 * 60° forwarding paddles | 2 × 90° reversing |
| 1 * 45° reversing paddle | Paddles |
| 3″ single lead screw | 4 × 45° reversing |
| 4 * 60° forwarding paddles | paddles |
| 2″ single lead screw | 2″ single lead screws |
| 2 * 60° forwarding paddles | Dies |
| 2 * 45° reversing paddles | |
| 2″ single lead screw | |

Extruded pellets were placed in a chamber of a Torbed drier (supplied by Torftech Ltd). Air was heated to 230° C. and blown into and out of (with some re-circulation) the chamber at a velocity sufficient to fluidise the particles—typically this is 800 ms⁻¹.

The extruded toasted snack pellets were roughly spherical or elitoid particles of approx. 6-8 mm in diameter and depth.

The compositions of the pellets of Batches 8.1 to 8.7 were as shown in Table 15b.

TABLE 15a

| | Batch No | | | | | | |
|---|---|---|---|---|---|---|---|
| | 8.1 | 8.2 | 8.3 | 8.4 | 8.5 | 8.6 | 8.7 |
| Freeze Dried | 24.2 | 24.2 | 23.8 | 23.8 | 16.1 | 56.4 | 56.4 |
| mycoprotein | | | | | | | |
| powder (% w/w) | | | | | | | |
| Wheat Starch | 56.5 | 56.5 | 55.5 | 55.5 | 64.5 | 24.2 | 24.2 |
| (% w/w) | | | | | | | |
| Sugar (% w/w) | 1.6 | 1.6 | 3.2 | 3.2 | 1.6 | 1.6 | 1.6 |
| Water (% w/w) | 17.7 | 17.7 | 17.5 | 17.8 | 17.7 | 17.7 | 17.7 |

EXTRUDER CONDITIONS

| | | | | | | | |
|---|---|---|---|---|---|---|---|
| Die Size (mm) | 6 | 6 | 4 | 4 | 4 | 4 | 4 |
| Barrel | 27/52/93/ | 27/52/93/ | 27/52/93/ | 27/52/93/ | 27/52/93/ | 27/52/93/ | 27/52/93/ |
| Temperature | 121/ | 121/ | 121/ | 121/ | 121/ | 121/ | 121/ |
| | 27149 | 27149 | 27149 | 27149 | 27149 | 27149 | 27149 |
| Screw Speed (RPM) | 440 | 440 | 440 | 440 | 440 | 440 | 440 |
| Feed Rate (kg/h) | 25 | 25 | 25 | 25 | 25 | 25 | 25 |

TORBED DRYER CONDITIONS

| | | | | | | | |
|---|---|---|---|---|---|---|---|
| Torbed Dryer | 230° C./65 | 230° C./30 | 230° C./30 | 230° C./60 | 230° C./60 | 230° C./30 | 230° C./60 |
| | seconds | seconds | seconds | seconds | seconds | seconds | seconds |

TABLE 15b

| | Batch No | | | | | | |
|---|---|---|---|---|---|---|---|
| | 8.1 | 8.2 | 8.3 | 8.4 | 8.5 | 8.6 | 8.7 |
| Freeze dried | 29.40 | 29.40 | 28.85 | 28.85 | 19.59 | 68.61 | 68.61 |
| mycoprotein (% w/w) | | | | | | | |
| Wheat | 68.65 | 68.65 | 67.27 | 67.27 | 78.47 | 29.44 | 29.44 |
| starch % w/w | | | | | | | |
| Sugar % w/w | 1.94 | 1.94 | 3.88 | 3.88 | 1.95 | 1.95 | 1.95 |

Details on the batches are provided in Table 15c

TABLE 15c

| SAMPLE | APPEARANCE | TASTE |
|---|---|---|
| 8.1 | Dark coloured, disc | Slightly burnt/over |
| | like pieces. Like oval | toasted taste. With |
| | shaped contact lens. | cereal notes and |
| | | slightly sweet |
| | | background |
| 8.2 | Light cream coloured | Very crispy product. |
| | product. Reminiscent | Sweet, with a slight |
| | of small corn flakes. | undefined back note. |
| 8.3 | Light brown product. | Light and crispy. |
| | Shape a cross between | Pleasant taste of |
| | Rice Krispies and | toasted cereal. Sweet |
| | Wheat puff, with a | with a slight background |
| | ‘ridge’ running down | tang. |
| | the middle of each | |
| | ‘grain. | |
| 8.4 | Dark coloured product | Sweet, strong but |
| | with the appearance of | pleasant toasted flavour |
| | strongly roasted nuts. | slightly stronger than |
| | | 8.3. |
| 8.5 | Similar to 8.3 but | Crumbly with a strong |
| | with a much darker | toasted cereal flavour. |
| | colour. | |
| 8.6 | Light coloured discs. | Quite hard and mealy |
| | Look like pellets. | with a tangy, bitter |
| | | flavour. |
| 8.7 | Dark, flat bi-coloured | Similar to 8.6 with a |
| | discs. Very dense | dark bitter taste. |
| | looking. | |

It will be appreciated that mycoprotein can be incorporated into extruded pellets at relatively high levels. Also, it was found that, at up to about 30% w/w mycoprotein solids, there was no discernible detriment to the flavour profile and, in fact, at up to that level, the downstream toasting appeared to result in flavour enhancement.

### EXAMPLE 8.3

### Preparation of Mycoprotein Puffed Snack Products

A mix comprising mycoprotein powder prepared as described in Example 8.1 (at respective levels of 5, 10 and 30% w/w mycoprotein) and maize grits was used as a feedstock for the extruder. Typically, the mix of Example 8.1 had an intrinsic moisture content of about 11% w/w. However, the typical powder feedstock for the extruder was arranged to have an intrinsic moisture content of about 18% w/w so some water injection was needed to raise the water content of the mixture in the barrel of the extruder to the desired level. The amount of moisture used will influence the behaviour and reactions of the materials in the barrel of the extruder where they are under high pressure and temperature and effectively melt at this point. The water content will also be under high temperature and pressure as the product exits the extruder. The sudden reduction to atmospheric pressure causes the water present as superheated steam to ‘flash off’ and in so doing expand the product leaving behind a series of pores in the product which will mirror the escape route of the steam. This effect causes a reduction in moisture content from say 18% w/w to approximately 6-10% w/w but sets up the expanded and porous nature typical of this expanded snack. The rapid reduction in temperature at this point also causes the starch to ‘solidify’ from the ‘melt’. In this way the desirable eating qualities of the snack product can be engineered. For the preparation of Batch No 8.8 of snack products, the feedstock was extruded using the extruder described in Example 8.2 using the extruder configuration No. 2 and target extruder settings of:

| Variable | Settings |
|---|---|
| Feedrate, g/min | 686 |
| Moisture, % | 18 |
| Screw speed, rpm | 300 |
| Die diameter, mm | 3 |
| Die numbers | 2 |
| Barrel temperature, ° C. | 30/50/90/120/140 |

The extrudate was cut with a two blade knife rotating at the die face. Puffed products of approx 25 mm length and 8-10 mm diameter were prepared.

For the preparation of Batch 8.10 of snack products, the extruder was initially configured as described for Batch No. 8.8 and extrudate was collected in a Stage No.1 of the preparation as for Batch No. 8.8. However, at the end of Stage No. 1, the extruder had to be unexpectedly shut down and when restarted in Stage No. 2 the temperatures in the extruder were lower than in Stage No.1 due to lower barrel settings—these were reduced from 140° C. in Stage No.1 to 40° C. in Stage No.2. Thus, the extruder would have tried to maintain this set point. The efficiency of this cooling is limited and so in the high shear/work final sections the mechanical energy input and frictional heat generated would have exceeded this capability and so the mass rose to approximately 118° C. (the recorded value of 98° C. was 20° C. under valued). In this way the barrel temperature gradient was approximately:

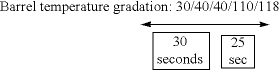

This compares with Stage 1 where the temperature in the mass at the exit point was 160-170° C.

A summary of the variables between Stage No's 1 and 2 is provided in Table 16.

TABLE 16

| Variables | Stage No.1 | Stage No.2 |
|---|---|---|
| Mass temperature ° C. | 170 | 98 |
| Die Pressure Mpa | 2.3 | 2.6 |
| Specific Mechanical Energy kJ/kg | 520 | 750 |

Results for Batches 8.8 and 8.9 (Stages No's 1 and 2) are summarised in Table 17a.

TABLE 17a

| Batch No | Comments |
|---|---|
| 8.8 | The product was approx 5-7 mm in diameter by 25 mm in |
| | length was of a yellow brown colour; and exhibited |
| | pleasant puffed texture with good initial bite. It |
| | was found to be possible to produce an extruded puffed |
| | product from feedstock having up to 30% w/w |
| | mycoprotein. The product resembled WOTSITS (Trade |
| | Mark), an extruded puffed snack/savoury snack. |
| | Whilst the addition of mycoprotein caused a reduction |
| | in the expansion of the maize grits even at 30% w/w |
| | the expansion was still within an acceptable range for |
| | a snack (4-5 ml/g). In other processing aspects, |
| | the addition of mycoprotein caused little change |
| | in the die pressures but caused a small increase |
| | in heat input and pressure. |
| 8.9 | Generally as per Batch 8.8. |
| (Stage | |
| No. 1) | |
| 8.10 | This was undertaken for the 30% w/w product. The |
| (Stage | puffed product produced in Stage 2 was 8-10 mm in |
| No.2) | diameter by 25 mm in length and exhibited a lighter |
| | more golden colour than in 8.8 and was considered more |
| | typical of snack products of this type. The product |
| | showed good initial bite and more of a melt in the |
| | mouth character than 8.8 when consumed. It is believed |
| | that the extrusion cooking in this example gave an |
| | improved product because the temperature was lower in |
| | the melt and at the die surface and this reduced the |
| | Maillard reaction and increased the fluid viscosity as |
| | indicated by the die pressure which may slightly |
| | modify the texture. |

Preferred total moisture in the feedstock for the extruder was in the range 19-21% w/w, although moisture content outside this range can still be used to produce acceptable products.

Initially, it had been thought that addition of mycoprotein in the manner described above would “poison” the starch melt at the surface of the snack as it left the extruder and in so doing would restrict the expansion. This, did not happen as much as expected—even less when the extruder was run at a cooler exit temperature. In fact, the product appearance of Batch 8.10 was surprisingly better than the other examples, it being a lighter more golden and expanded snack.

Furthermore, it is known that processing maize grits in the manner described for producing an expanded snack, is undertaken ideally at a temperature in excess of 140° C. in order to develop the pleasant “popcorn” flavour. At temperatures as low as 120° C. in the melt, the maize would be expected to take a slight “beany” sour milk overtone. However, this did not occur when extruded at low temperature in the presence of mycoprotein.

At higher process temperatures, products at 10% w/w and 20% w/w mycoprotein were preferred for colour and expansion over those prepared at 30% w/w. The Batch 8.10 product, at 30% w/w, was most acceptable and closer in characteristics to the 10% w/w product produced in Stage 1. Thus, lower temperature extrusion appears to be a way by which it is possible to increase the level of mycoprotein in the product and maintain acceptability.

### EXAMPLE 8.4

### Preparation of Mycoprotein Extruded Bullets

Using a process generally similar to that described in Example 8.3, except that the conditions described in Table 17b were used, bullet-like products made of mycoprotein powder/wheat flour were prepared at mycoprotein levels of up to 30% w./w in the finished product.

TABLE 17

| Variable | Settings |
|---|---|
| Feedrate g/min | 550-450 |
| Moisture, % w/w | 17-18 |
| Screw speed, rpm | 257 |
| Die diameter, mm | 2 |
| Die numbers | 6 |
| Barrel temperature, ° C. | 30/50/90/120/120 |

It was found that the mycoprotein could advantageously be included in bullet type extrudate with wheat flour and the extrudate had the same type of flavour and colour as for the maize products referred to above. The extruded products were of 3.5-4 mm diameter and length 6-8 mm. It was observed that the mycoprotein caused the expansion of the extrudate to be isotropic thus giving more length-wise expansion of wheat flour on its own. Furthermore, the temperature of the processing was similar to that for maize incorporating 30% w/w mycoprotein (160° C.) and the pressure was lower at 1.5 MPa at the lower feed rates used for bullets.

It is believed that ball-shaped extrudate could be produced using a 4-blade cutter knife and higher cutting speeds.

### EXAMPLE 8.5

### Preparation of Mycoprotein-Containing Confectionery Bar

Confectionery bars were prepared using the “bullets” prepared in Example 8.4 in accordance with the following formulation

| | % w/w |
|---|---|
| Rolled Oats | 23.11 |
| Diced Dried Apricots | 4.99 |
| Mycoprotein bullets | 18.49 |
| Puffed Rice | 8.32 |
| Salt | 0.08 |
| Vegetable Oil | 4.99 |
| Glucose Syrup | 24.0 |
| Golden Syrup | 12.3 |
| Invert Sugar Syrup | 8.71 |

The method used was as follows:

1. Blend together cereals and vegetable oils. Warm to 75° C.

2. Blend sugar syrups and heat to 100° C.

3. Add to cereal mix.

4.Mix together on slow speed until mass is combined.

5. Add dried fruits and mix until evenly combined. Turn out and press into required shape.

6. Cool and cut.

The bars were found to eat well, with the presence of the mycoprotein/starch (i.e. wheat flour) not detracting from the eating quality.

As described above, it has been found that up to about 30% w/w of dry mycoprotein can be incorporated into, for example pellets or bullets. At this level, sufficiently high levels of nutrients may be present for the product to deliver significant health benefits. The nutrient levels may be calculated based on details in Table 7b.

A confectionery bar as described in Example 8.5 may be prepared as a 75 g single serving size. Using mycoprotein bullets having 30% w/w dried mycoprotein delivers 4.05 g dry wt of mycoprotein solids which may be high enough to deliver health benefits as described above.

### EXAMPLE 9

### Preparation of Pasta Dough using Mycoprotein Solids

Pasta dough was prepared by mixing durum semolina (2000 g) with the freeze dried and milled mycoprotein solids (550 g) and with water (620 g). The ingredients were mixed initially for five minutes; the dough was then rested; thereafter, the dough was mixed for a further five minutes; and then it was extruded through multiple dies.

The pasta dough prepared was cooked in slightly salted water until al dente.

The dough prepared which included 17.4% w/w mycoprotein (on a dry matter basis) gave good results in both extrusion and shaping of a pasta product. The eating quality of the pasta produced was good. Experienced assessors believed pasta produced exhibited superior bite compared to products without mycoprotein. Furthermore, eating quality appeared to be maintained for longer than was expected when held at serving temperatures.

The mycoprotein can be incorporated into paste at relatively high levels such that the nutrients in the mycoprotein may deliver health benefits as described above.

### EXAMPLE 10

### Preparation of an Ambient Stable Reconstitutable Soup

The spray dried mycoprotein and skim milk powder of Example 6d was mixed with dehydrated ingredients in order to produce an ambient stable reconstitutable soup. All powders were packed into foil sealed sachets to allow the consumer to open and reconstitute with either skim milk or water to give 250 ml servings of a flavoured soup.

A summary of the examples of the types of formulations that can be produced is given in Table 18.

| Ingredient | % powder mix |
|---|---|
| Mycoprotein/milk powder | 55.25 |
| Inulin | 12.43 |
| Vegetable protein | 12.43 |
| concentrate | |
| Vitamin and mineral mix | 6.63 |
| Croutons | 9.67 |
| Salt | 1.38 |
| Flavour | 1.38 |
| Powdered onion | 0.83 |

Each serving (about 40 g per sachet) contains one-third of the recommended daily amount (RDA) of key vitamins and minerals and is high fibre, high protein, low fat and contains 10 g of mycoprotein solids.

The product was assessed by trained sensory panellists and was found to be of excellent drinking quality.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extend to any novel one, or any novel combination, of the features disclosed in this specification (including any accompanying claims, abstract and drawings), or to any novel one, or any novel combination, of the steps of any method or process so disclosed.

1. A solid first food ingredient comprising edible fungal particles having a dimension in a first direction of less than 200 μm, wherein said dimension in said first direction is a maximum dimension of said particles.

2. A food ingredient according to claim 1, wherein said edible fungi comprises filamentous fungus and the edible fungi used in the method includes at least 80 wt % of fungal mycelia.

3. An ingredient according to claim 1, wherein said fungal particles comprise fungus selected from fungi imperfecti.

4. An ingredient according to claim 1, wherein said fungal particles comprise cells of Fusarium species.

5. An ingredient according to claim 1, which includes at least 30% w/w of said edible fungal particles on a dry weight basis.

6. An ingredient according to claim 1, said ingredient including at least 80% w/w of said edible fungal particles on a dry matter basis.

7. An ingredient according to claim 1, which includes another source of protein in addition to said edible fungal particles.

8. An ingredient according to claim 1, which is a particulate solid.

9. An ingredient according to claim 1, which includes 0 to 10% w/w of water.

10. An ingredient according to claim 1, wherein the number average of said first dimensions of said fungal particles in the food ingredient is less than 200 μm.

11. A solid first food ingredient comprising edible fungal particles having an average aspect ratio of less than 70.

12. The use of a solid first food ingredient comprising edible fungal particles in the preparation of a foodstuff for consumption or a second food ingredient.

13. A method of preparing a foodstuff for consumption or a second food ingredient, the method comprising contacting a solid first food ingredient comprising edible fungal particles with other ingredients of said foodstuff or second food ingredient.

14. A method according to claim 13, wherein the amount of said first ingredient is selected such that there is at least 2% w/w of edible fungi on a dry matter basis.

15. A method according to claim 13, wherein said foodstuff is a dairy product.

16. A method according to claim 13, wherein said foodstuff includes milk and/or milk powder.

17. A method according to claim 13, wherein said foodstuff for consumption or said second food ingredient is a solid.

18. A method according to claim 17, which includes making said solid in a substantially predetermined shape.

19. A method according to claim 17, wherein said solid is formed in a process using heat and/or pressure.

20. A method according to claim 17, which includes extruding a mixture comprising said first food ingredient and at least one other ingredient.

21. A method according to claim 20, wherein said mixture includes at least 4.5% w/w of said first food ingredient.

22. A method according to claim 17, used to prepare foodstuffs or second food ingredients of 15% w/w or more of edible fungi.

23. A method according to claim 20, wherein said at least one other ingredient is selected from a carbohydrate and a protein.

24. A method according to claim 17, wherein said first food ingredient is mixed with water in conjunction with starch and/or sugar and the mixture extruded to produce solid products.

25. An extruded foodstuff which comprises edible fungi.

26. The use of an edible fungus in the preparation of a foodstuff for the treatment of joint mobility disorders; for reducing fat uptake; for lowering cholesterol; for immune function stimulation; and a pre-biotic and/or for affecting satiety.

27. A method of preparing a foodstuff having at least 200 mg of N-acetylglucosamine per 100 gm of foodstuff; and at least 600 mg of β-glucan per 100 gm of foodstuff, the method comprising contacting edible fungi with other ingredients of said foodstuff, the method comprising contacting edible fungi with other ingredients of said foodstuff.

28. A foodstuff having at least 300 mg of N-acetylglucosamine and at least 600 mg of β-glucan per 100 gm of foodstuff.

29. A solid first food ingredient comprising edible fungal particles having a dimension in a first direction of less than 200 μm, wherein said dimension is a maximum dimension of said particles ; and an average aspect ratio of less than 70, wherein said ingredient includes at least 30% w/w of said edible fungal particles on a dry matter basis together with another source of protein in addition to said edible fungal particles.
